(19) United States
(12) Patent Application Publication
(10) Pub. No.: US 2017/0048652 A1
(43) Pub. Date: Feb. 16, 2017

(54) SYSTEMS AND METHODS FOR ENABLING CELLULAR DATA NETWORK ACCESS TO PORTABLE DEVICES VIA A SMARTWATCH INCLUDING A SIM THEREIN

(71) Applicants: Arturo Del Rio, Las Cruces, NM (US); Luis M. Ortiz, Albuquerque, NM (US)

(72) Inventors: Arturo Del Rio, Las Cruces, NM (US); Luis M. Ortiz, Albuquerque, NM (US)

(21) Appl. No.: 15/234,553

(22) Filed: Aug. 11, 2016

Related U.S. Application Data
(60) Provisional application No. 62/204,048, filed on Aug. 12, 2015.

(51) Int. Cl. H04W 4/00; H04W 60/00; H04W 12/08; H04W 8/18; H04W 12/06

(52) U.S. Cl. CPC H04W 4/008; H04W 8/183; H04W 12/06; H04W 12/08; H04W 60/00; H04W 76/023

(57) ABSTRACT

Systems and methods enabling cellular data telecommunications carrier network access to portable devices via a smartwatch are disclosed. A smartwatch can include a subscriber identification module (SIM), a wireless cellular data network communications module, and a short-range wireless data communications module. A registration module can facilitate registration of portable devices with the smartwatch to receive, obtain, and transmit voice, data, and text on behalf of the user from a network carrier through the smartwatch when the smartwatch is in communication with the network carrier via the wireless cellular data network communications module and when the portable devices are within short-range radio frequency communication with the smartwatch via the short range wireless data communications module. Smartwatch users can be authenticated to use the smartwatch, access carrier networks, and register portable devices via biometric means including voice recognition, skin analysis, and recognition, or a combination of measurements.

### INVENTION PRIORITY

The present invention claims priority to U.S. Provisional Patent Application Ser. No. 62/204,048 entitled “SYSTEMS AND METHODS FOR ENABLING CELLULAR DATA NETWORK ACCESS TO PORTABLE DEVICES VIA A SMARTWATCH INCLUDING A SIM THEREIN,” filed Aug. 12, 2015, which is herein incorporated by reference in its entirety.

### TECHNICAL FIELD

Embodiments generally relate to the field of wireless telecommunications. Embodiments additionally relate to subscriber identity modules (SIMs), whether provided in the format of physically removable module containing subscriber info for identification to a telecommunications carrier or are integrated in a permanent memory as part of a mobile phone (e.g., MEID) to identify it to a telecommunications carrier. Embodiment also generally relate to mobile phones that store information required to identify a mobile device user (identification and personal number) and support secure communications with a cellular telecommunications network. More particularly, embodiments related to system and methods for enabling cellular data network access to portable devices via a single smartwatch including a subscriber identity module therein to universally provide telecommunications carrier services to multiple portable devices (e.g., smartphones, tablet computers).

### BACKGROUND OF THE INVENTION

Electronic wireless hand held devices, such as data/video-enabled cellular telephones (often referred to as “mobile phones” or “smartphones”), tablet computers, and other portable, hand held wireless data-enabled devices have become a part of everyday life. Such mobile device are capable of multimedia data transmission and retrieval from multiple networks and wireless connections including: cellular (including 4G/LTE, 802.11 WiFi networks), short range radio frequency, and/or line of sight communications standards and networks such those that are standardized including Bluetooth, Bluetooth LE, IrDA (infrared), RFID, NFC, and other proprietary, secure means that are not yet standardized. Many current mobile devices are capable of determining location information and directions using GPS and by displaying maps retrieved from remote servers (e.g., via the Internet), include touch sensitive display screens, and incorporate high-resolution cameras. Mobile devices are capable of moving data to/from, and operating with, removable cartridges (e.g., external memory, smart card, card-based application modules, and electronics), and/or via wireless communication to neighboring devices.

A subscriber identity module or subscriber identification module (SIM) is known as an integrated circuit on a removable card that is intended to securely store the international mobile subscriber identity (IMSI) number and its related key, which are used to identify and authenticate a subscriber of a single mobile device. It is also possible to store contacts on the SIM cards. SIM cards are always used on GSM phones; for CDMA phones, they are only needed for newer LTE-capable handsets. Some COMA devices also have a similar card called a R-UIM. SIM cards can also be used in satellite phones. Individual GSM, WCDMA, iDEN, and some satellite phone devices are uniquely identified by an International Mobile Equipment Identity (IMEI) number. A Mobile Equipment Identifier (MEID) is 14 digits long and is used to identify a cell phone that utilizes the COMA technology for wireless service. CDMA phones don't typically have SIM cards and CDMA (Code Division Multiple Access) is just a type of technology used for wireless phone service. An International Mobile Station Equipment Identity, or IMEI for short, is a number that identifies mobile phones that run on a GSM network. GSM is just another type of wireless technology used for mobile service.

The SIM card is part of the function of a Universal Integrated Circuit Card (UICC) physical smart card, which is usually made of PVC with embedded contacts and semiconductors. SIM cards are designed to be transferable between different mobile devices, but can only be used on one device at a time. The first UICC smart cards were the size of credit and bankcards; the development of physically smaller mobile devices has prompted the development of smaller SIM cards, where the size of the plastic carrier is reduced while keeping electrical contacts the same. SIM cards will continue to shrink in size as devices become smaller to enable portability.

A SIM card contains its unique serial number (ICCID), international mobile subscriber identity (IMSI) number, security authentication and ciphering information, temporary information related to the local network, a list of the services the user has access to, and two passwords: a personal identification number (PIN) for ordinary use and a personal unblocking code (PUK) for PIN unlocking.

There are so many portable devices available to users. It is not uncommon for a user to have two or three devices with them at a time that enable at least some form of wireless communication (e.g., Wi-Fi, Bluetooth, NEC) and data access, even if access is limited to only 802.11 hotspot access for the devices not equipped with a SIM. Wearable devices are also now available that includes computing and wireless communication capabilities. Examples of what is currently being referred to as “smartwatches” include Apple Corporation's “Apple Watch”, Samsung Corporation's “Gear”™, Sony “SmartWatch”™, and LG Urbane™. Recently, Samsung and LG began providing smartwatches incorporating SIMs. Users requiring telecommunications network access are typically limited to accessing a cellular data network with their smartphone devices, it typically being the only device carried by the user with a SIM and associated wireless carrier subscriber account. For many users, it is not economically feasible to have multiple subscriber accounts (and increased costs) to enable wireless cellular network communications for all of their portable devices.

What is needed are systems, methods, and apparatuses that enables a user of a smartwatch including a SIM card or embedded identification information associated subscriber account to enable the smartwatch to serve universally as the single, common portal for the user's many other portable devices and enable all devices including the smartwatch to receive/obtain/transmit data on behalf of the user.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole. Reference to “subscriber identity module” or “SIM” throughout the rest of this document shall refer to a module (whether physical or embodied in device memory) that is used to identify all variations of phones regardless of carrier, including mobile devices having and providing a Mobile Equipment Identifier (MEID) to identify a cell phone that utilizes the CDMA technology for wireless service, or an International Mobile Station Equipment Identity (IMEI) to identify mobile phones that run on a GSM network.

It is, therefore, one aspect of the disclosed embodiments to provide improved systems and methods that enable a smartwatch including a SIM and associated subscriber account associated therewith to serve as the single, common portal for the smartwatch users many other devices and enables all devices including the smartwatch to receive/obtain/transmit data on behalf of the user.

It is, therefore, one aspect of the disclosed embodiments to provide improved systems and methods that enable a SIM-enabled smartwatch with an associated subscriber account to serve as the single, common portal for the smartwatch user's many other devices (e.g., smartphone, tablet computer, laptop) and enables the devices including the SIM-enabled smartwatch to receive/obtain/transmit voice, data, and text on behalf of the user when the many other devices are within short distance radio frequency communication range (e.g., Bluetooth communication range) of the smartwatch.

It is yet another aspect of the disclosed embodiments to enable a smartwatch that includes a SIM incorporated therein and an associated subscriber account to authenticate a user for access to at least one of a carrier cellular network, a portable device requesting access, and applications on the smartwatch.

It is yet another aspect of the disclosed embodiments to enable a smartwatch in the form of a smartwatch to include a SIM and associated subscriber account associated therewith and serves to authenticate a user utilizing biometrics obtained from a user by the smartwatch.

It is yet another feature for biometrics used to authenticate a user by the smartwatch to include voice authentication via a microphone integrated with the smartwatch, skin layer illumination using a laser light source integrated within the smartwatch when in contact with a user skin, vital patterns (e.g., heart rate pattern) obtained via the light source integrated within the smartwatch when in contact with a users skin, or any combination.

These and other features and embodiments of the present invention will become apparent to the skilled after reading the following detailed description and the appended claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the present invention.

FIG. 1 illustrates a block diagram of a smartwatch including, inter alia, a universal SIM, cellular communications module, Bluetooth communications module, and specialized application software, which can be implemented in accordance with embodiments of the present invention;

FIG. 2 illustrates a pictorial representation of a smartwatch as illustrated in FIG. 1 supporting voice/data/text communications with a wireless carrier for several other devices without their need for or use of dedicated SIMs, which can be implemented in accordance with the embodiments; and

FIGS. 3-4 illustrate flow diagrams for methods of providing a user of a smartwatch including a SIM therein to provide universal access to a carrier network for plural registered portable devices.

### DETAILED DESCRIPTION

The particular values and configurations discussed in these non-limiting examples can be varied and are cited merely to illustrate at least one embodiment and are not intended to limit the scope thereof.

Unlike personal computers, which are general-purpose devices geared towards refining and processing information, modern mobile communication devices are designed to capture, store, and display information originating from various sources while a user is “on the go” or otherwise mobile. Additionally, while a certain level of skill is required to use a personal computer effectively, mobile devices are designed with the novice and non-computer user in mind and are therefore intuitively easy to use. Mobile communications devices are typically used in a smartphone or tablet format. Either of these particular device formats can include a SIM (e.g., EMIE and MEID information) to provide user access to carrier networks and account data (including voice, text, and application specific date retrievable remotely from servers).

A typical smartphone or tablet further includes a microprocessor, memory unit, a display, associated encoder circuitry, and a user interface generally provided in the form of a keyboard and selector buttons. Many mobile devices in the form of smartphones and tablets can optionally contain an infrared emitter and wireless receiver. A graphical user interface permits a user to store, retrieve, and manipulate data via an interactive touch-sensitive display. A mobile device can also include software that enables software applications for using a calendar, directory, calculator, games, and one or more multimedia programs. The calendar typically provides dates organized as rows and columns in the usual form. A directory contains entries consisting of a name field and a free form alphanumeric text field that can contain company names, addresses, telephone and fax numbers, email addresses, etc. Games and multimedia software features can vary.

A menu of icons displayed via the graphical user interface as part of the touch sensitive screen can permit a user to choose particular functions and directories. Some mobile devices come equipped with a stylus, which is a plastic-tipped pen that a user utilizes to write digitally on the display area and tap particular graphically displayed icons; although a users figure nail can accomplish the same. Each icon is indicative of a particular activity or function. Touch screen interfaces, however, are also increasingly being implemented with mobile devices to permit a user to activate software modules in the form of routines and subroutines operable therein. Note that as utilized herein, the term “data” as utilized herein generally refers to signals that can be presented in the form of text, voice, graphics, and/or video, but can include other types of data such as software, security codes, encryption, decryption, etc. Such data can include, for example, “multimedia data” such as video, voice, audio, etc. It should be appreciated that mobile devices can also be developed in a form factor similar to smartphones and tablet computers that are restricted to proprietary uses and include added security features. U.S. Pat. No. 9,031,537, issued to Ortiz et al., which is entitled “Electronic Wireless Hand Held Multimedia Device”, is representative of such a device and is incorporated herein by reference for its teaching.

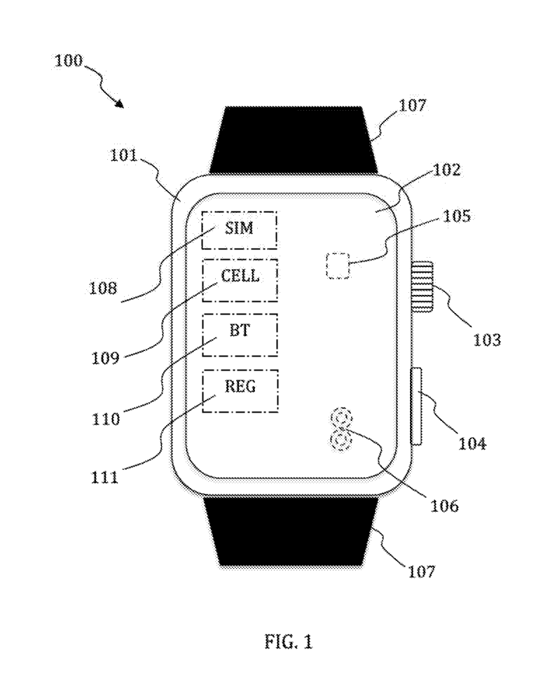

Referring to FIG. 1, illustrated is a diagram of a smartwatch 100, which includes a housing 101 having an integrated display screen 102, physical user interfaces 103/104, integrated microphone 105, skin illumination/reading sensors 106, and straps 107 to secure the smartwatch to a user's wrist. The display screen can be touch-sensitive and can provide part of the user interface with the smartwatch 100. The physical user interfaces can be provided in the form of a rotatable crown 103 and a push-button 104. Also included therein are a subscriber identity module (SIM) 108, cellular RF communications module 109, Bluetooth communications module 110, and specialized application software registration module 111. The SIM enables communication for authorized user with a carrier's network (e.g., Verizon, Sprint AT&T, etc.) to enable a user to receive/place voice calls, receive/transmit text messages, and access data networks. The cellular communications module 109 and Bluetooth communications module 110 each indude radio frequency (RF) transceivers that support bi-directional data communications of the smartwatch 100. The cellular communications module 109 supports RF communication of the smartwatch 100 with a cellular data telecommunications networks provided by telecommunications carriers (e.g., GSM, CDMA, etc.). Bluetooth communications module 110 supports RF bi-directional data communications of the smartwatch 100 with other portable devices, such as smartphones, tablet computers, and laptop computers. Registration module 111 provides specialized application software to support registration of a user's portable device with the smartwatch, and facilitates the establishment of wireless communication between the smartwatch 100 and registered portable devices, and between the registered portable devices and the telecommunications carrier supporting the smartwatch. A user can be authenticated for carrier network access and communication with portable devices via biometric authentication, which can be facilitated by the registration module 111. Biometrics can be obtained from a user via voice spoken into the microphone 105, or by obtaining skin measurements via skin illumination and reading hardware 106, or a combination of both biometrics.

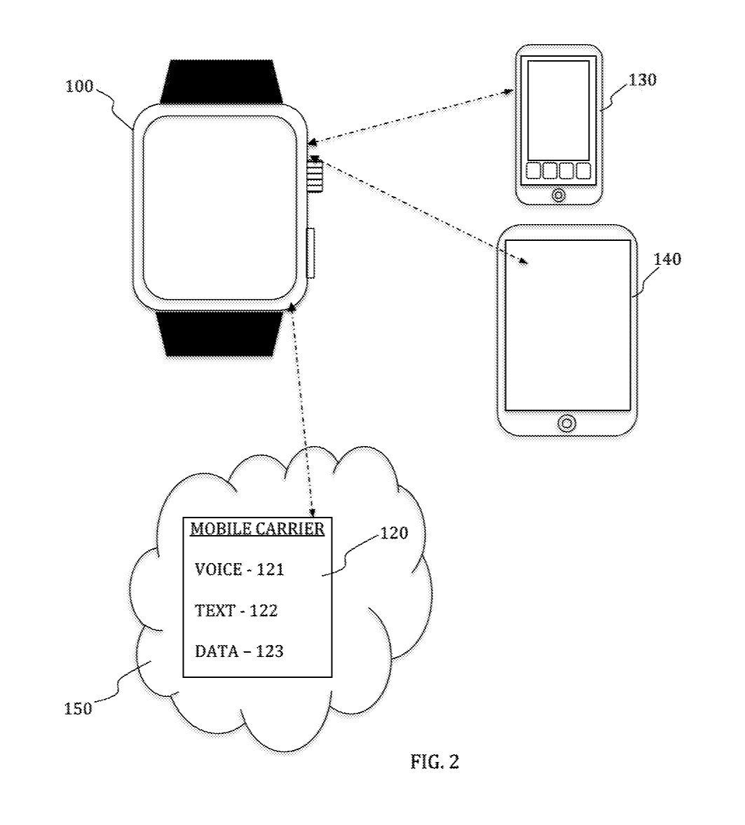

FIG. 2 illustrates a block diagram representing a smartwatch 100 as illustrated in FIG. 1 supporting voice 121, text 122, and data 123 communications with a wireless carrier 120 for the smartwatch 100 and also for other portable devices in the form of a smartphone 130 and a tablet computer 140. Once communications with the carrier network is established 120, the smartwatch can gain access to broader data network resources 150 (e.g., Internet access). The portable devices 130/140 can be registered with the smartwatch 100 using registration module 111 for communication with/through a carrier network without the need for their own subscriber identity modules. It should be understood that initial registration of portable devices for carrier network related data access is different from merely setting up a Bluetooth connection (“pairing”) with the portable devices.

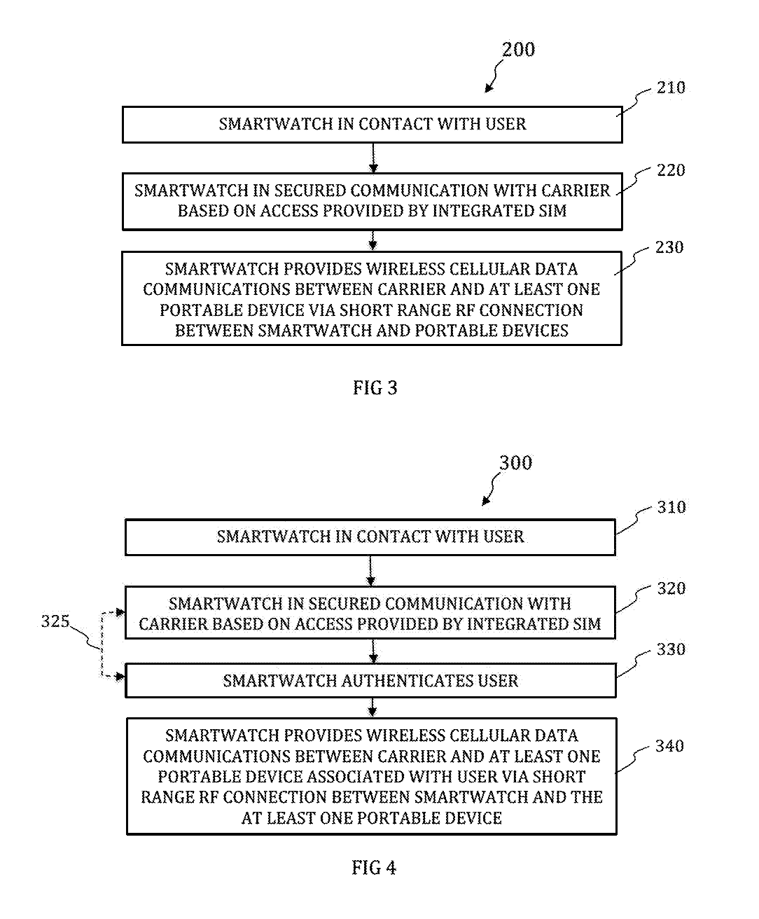

FIGS. 3-4 illustrate flow diagrams of methods of providing a user of a smartwatch, which includes a universal SIM, access to data and electronic systems. Referring to the flow diagram 200 in FIG. 3, a smartwatch is placed in contact with a user as shown in block 210. Contact can refer to the placement of a smartwatch on the wrist of a user in a manner where it is strapped snuggly so that the back of the smartwatch contacts the skin of a user. As shown in block 220, the smartwatch obtains secured communication with a telecommunications carrier based on access provided by a SIM integrated in the smartwatch. To obtain communications, the SIM must typically be registered with an active user account. An account will normally include a cellular number. Then, as shown in block 230, the smartwatch provides wireless cellular data communications between the carrier's network and at least one portable device via short-range radio frequency communications (e.g., Bluetooth) between the smartwatch and portable devices. The portable devices are registered with the smartwatch and recognized when short-range communications are established between them (e.g., Bluetooth pairing is accomplished).

Referring to FIG. 4, a flow diagram 300 illustrates another method of communications between smartwatches and portable devices in accordance with the embodiments. Referring to block 310, a smartwatch is placed in contact with a user. Then referring to block 320, the smartwatch establishes secured communication with a carrier network based on access provided by the integrated SIM. The smartwatch can then authenticate the user, as shown in block 330. As shown by arrow labeled 325, block 330 can precede block 320 (authentication before network access). When authentication occurs, it depends on whether authentication will require remote resources provided by the carrier or if authentication will only occur at the smartwatch. Authentication can be accomplished by password entry on the user interface (e.g., touch screen) of the smartwatch or by using the smartwatch to obtain biometric information from the user. Biometrics can include voice or skin illumination measurements as described before. Referring to block 340, the smartwatch will then provide wireless cellular data communications between the carrier network and at least one portable device (e.g., smartphone, tablet computer, laptop) associated (e.g., registered) with the user via a short range RF connection (e.g., Bluetooth device pairing) between the smartwatch and the at least one portable device.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system for enabling cellular data telecommunications carrier network access to portable devices via a smartwatch, said system comprising:
a smartwatch including a subscriber identification module (SIM), a wireless cellular data network communications module, and a short range wireless data communications module; and
a registration module facilitating registration of portable devices with the smartwatch to receive, obtain, and transmit voice, data, and text on behalf of the user from a network carrier through the smartwatch when the smartwatch is in communication with the network carrier via the wireless cellular data network communications module and when the portable devices are within short-range radio frequency communication with the smartwatch via the short range wireless data communications module.

2. The system of claim 1, wherein carrier network access is determined by the wireless cellular data communications network module and SIM.

3. The system of claim 1, wherein the wireless cellular data communications network module and SIM support cellular data communications with the carrier network.

4. The system of claim 1, wherein the short range wireless data communications module is a Bluetooth communications standard module.

5. The system of claim 1, further comprises of biometric authentication hardware including at least one of a microphone and a skin illumination and analysis hardware.

6. The system of claim 2, wherein the short range wireless data communication module is a Bluetooth communications standard module.

7. The system of claim 2, further comprises of biometric authentication hardware including at least one of a microphone and a skin illumination and analysis hardware.

8. The system of claim 5, wherein carrier network access is determined by the wireless cellular data communications network module and SIM.

9. The system of claim 5, wherein the short range wireless data communications module is a Bluetooth communications standard module.

10. A method for enabling cellular data telecommunications carrier network access to portable devices via a smartwatch, said method comprising:
placing a smartwatch in contact with a user;
obtaining secured communication between the smartwatch and a carrier network based on access provided by a SIM integrated in the smartwatch; and
providing wireless cellular data communication between the carrier network and at least one portable device via short-range radio frequency communication between the smartwatch and the at least one portable device.

11. The method of claim 10, further comprising authenticating a user of the smartwatch before obtaining secured communication between the smartwatch and a carrier network.

12. The method of claim 11, wherein authentication of the user is by biometric means.

13. The method of claim 12 wherein authentication of the user by voice recognition.

14. The method of claim 12, wherein authentication of the user is by skin analysis and recognition.

15. The method of claim 10, further comprising registering the at least one portable device with the smartwatch prior to enabling carrier network access to the at least one portable device via the smartwatch.

16. A method for enabling cellular data telecommunications carrier network acc s to portable devices via a smartwatch, said method comprising:
placing a smartwatch in contact with a user;
authenticating the user;
obtaining secured communication between the smartwatch and a carrier network based on access provided by a SIM integrated in the smartwatch;
registering at least one portable device to communicate with the smartwatch and access carrier network access; and
providing wireless cellular data communication between the carrier network and at least one portable device via short-range radio frequency communication between the smartwatch and the at least one portable device.

17. The method of claim 16, wherein authentication of the user is by biometric means.

18. The method of claim 16, wherein authentication of the user is by voice recognition.

19. The method of claim 16, wherein authentication of the user is by skin analysis and recognition.
